(19) United States
(12) Patent Application Publication
(10) Pub. No.: US 2016/0048620 A1
(43) Pub. Date: Feb. 18, 2016

(54) METHOD FOR SIMULATING CIRCUIT USING BASIS FUNCTION AND SAVING MEDIUM TO WHICH CIRCUIT SIMULATION PROGRAM IS SAVED

(71) Applicant: SNU R&DB FOUNDATION, Seoul (KR)

(72) Inventors: Ji Eun JANG, Seoul (KR); Jae Ha KIM, Seoul (KR)

(21) Appl. No.: 14/781,265

(22) PCT Filed: Feb. 7, 2013
(86) PCT No.: PCT/KR2013/000973

§ 371 Date: Sep. 29, 2015

(51) Int. Cl. G06F 17/50; G06F 17/10

(52) U.S. Cl. CPC G06F 17/5036; G06F 17/10

(57) ABSTRACT

Disclosed is a method of simulating an electronic circuit or system. The method includes receiving an input stimulus represented as a linear combination of one or more basis functions and their coefficients and the circuit or system described in an s-domain transfer function, calculating the response of the circuit or system to the input stimulus whenever the input coefficients change based on the s-domain representations of the input stimulus and circuit or system using an event-driven method, and converting the response to a representation using a linear combination of one or more basis functions and their coefficients.

### TECHNICAL FIELD

The present invention relates to a method of simulating an electronic circuit or system of which signals are in forms of basis functions and a recording medium storing a simulation program using the method.

### BACKGROUND ART

Most of the computer simulation tools widely in use for electronic circuits or systems, such as Simulation Program with Integrated Circuit Emphasis (SPICE) and MATLAB Simulink, express the continuous-time waveforms of voltage or current signals using a series of time-value pairs. In other word, each waveform is expressed using a set of discrete points each marking the signal value at a specific time. To compute such a waveform of the circuit or system in response to a certain stimuli, the ordinary differential equation governing the behavior of the circuit is typically solved using a numerical integration method such as trapezoidal method.

### DISCLOSURE

### Technical Problem

Expressing the continuous-time signal waveforms in electronic circuits or systems using a set of time-value pairs leads to a conflicting trade-off between the accuracy and efficiency. For instance, an accurate expression of a continuous-time signal waveform demands a large number of discrete points (i.e. time-value pairs) while computing those discrete points requires long computation time or large data storage. For example, consider a case of expressing a unit-frequency sinusoidal waveform with a set of uniformly-spaced sample points. If the sample points are spaced at 100 millisecond intervals (i.e. ten samples per period), the resulting piecewise-linear waveform connecting these points would have too large a discrepancy error compared to the original sinusoidal waveform. On the other hand, if the sample points are spaced at 1 microsecond intervals (i.e. one million samples per period), the resulting waveform would be very close to the original waveform but the number of points required is large.

Such a conflicting trade-off between the accuracy and efficiency is mainly due to the fact that the existing computer simulation tools calculate the responses of a circuit or system at discrete intervals using a numerical method instead of the event-driven method described in this invention. Here, the event-driven method refers to a method of computing the output response waveform of a circuit or system only when one of the coefficients describing the input waveforms has changed. Here, each of the input waveforms is represented as a linear combination of one or more basis functions and their coefficients, describing the input signal as a function of time. The waveform of each output response of the circuit or system is then also computed in the same representation using a linear combination of one or more basis functions and their coefficients. With this event-driven method, the accuracy and efficiency of the simulation no longer depend on the time intervals between the time-value pairs representing the waveform.

The present invention pertains to a method of representing the continuous-time analog signals of electronic circuits or systems in a form of a linear combination of one or more basis functions and their coefficients and computing the corresponding coefficients using this event-driven method. Also, the present invention is applicable to the event-driven simulation of any linear dynamical system in general, although the present disclosure uses the electronic circuits or systems as the primary example.

### Technical Solution

One aspect of the present invention provides a method of simulating the output response of an electronic circuit or system, the method including: receiving an input stimulus in a form of a linear combination of one or more basis functions and a set of coefficients describing the input stimulus signal as a function with respect to time; converting the input stimulus in a form of a linear combination of one or more basis functions and a set of coefficients to an s-domain equation; obtaining an s-domain equation of the input-to-output transfer function of the electronic circuit or system; and calculating the output response of the electronic circuit or system in a form of a linear combination of one or more basis functions and a set of coefficients describing the output response signal as a function with respect to time.

As an example, the said basis functions may be in a form of c·t^{m-1}e^{-at}μ(t) where the coefficients c, m, and a are complex-valued constants and u(t) is a unit step function.

As an example, the input-to-output transfer function may be in a partial fraction expanded form in s domain.

As an example, the input-to-output transfer function may be found by converting a differential equation representing the electronic circuit or system into an s domain, or by using a Laplace equivalent circuit model of the electronic circuit or system.

As an example, the calculating the output response of the electronic circuit or system in a form of a linear combination of one or more basis functions and a set of coefficients describing the output response signal as a function with respect to time comprises: mulitplying the s-domain equation of the input stimulus and the s-domain equation of the input-to-output transfer function of the electronic circuit or system; performing a partial fraction expansion of the result of the multiplication; and converting the result of the partial fraction expansion into a form of a linear combination of one or more basis functions and a set of coefficients.

As an example, the method may further include plotting the output response waveform graphically by evaluating the expression in a form of a linear combination of one or more basis functions and a set of coefficients at one or more time points.

Another aspect of the present invention provides a recording medium storing a circuit simulation program including: receiving an input stimulus in a form of a linear combination of one or more basis functions and a set of coefficients describing the input stimulus signal as a function with respect to time; converting the input stimulus in a form of a linear combination of one or more basis functions and a set of coefficients to an s-domain equation; obtaining an s-domain equation of the input-to-output transfer function of the electronic circuit or system; and calculating the output response of the electronic circuit or system in a form of a linear combination of one or more basis functions and a set of coefficients describing the output response signal as a function with respect to time.

### Advantageous Effects

According to an exemplary embodiment, the output response of an electronic circuit or system is found in a form of one or more basis functions and a set of coefficients describing the output response signal as a function with respect to time. Also, the said linear combination of the basis functions and the coefficients are updated only when the linear combination of the basis functions and the coefficients of the input stimulus change, significantly reducing the required computational effort for the simulation. It is in contrast to the related prior arts, which compute the output responses in forms of a set of discrete points and must update the output responses even when the input stimulus has not changed. As a result, the present invention can achieve the superior accuracy and efficiency in simulating electronic circuits or systems.

### DESCRIPTION OF DRAWINGS

FIG. 1 is a flowchart illustrating an operation according to an exemplary embodiment.

FIG. 2 is a diagram exemplifying a circuit input by a user.

FIG. 3 shows the s-domain equivalent circuits of a resistor, an inductor, and a capacitor.

FIG. 4 shows an s-domain equivalent circuit of a circuit input by a user.

FIG. 5 shows diagrams for comparison between the exemplary embodiment and a commercial simulation program.

FIG. 6 is a flowchart illustrating in detail a process in which the linear combination of basis functions and their coefficients of the output response is updated every time the linear combination of basis functions or their coefficients of the input stimulus change, that is, every time an event occurs, in the electronic circuit or system.

### MODE FOR INVENTION

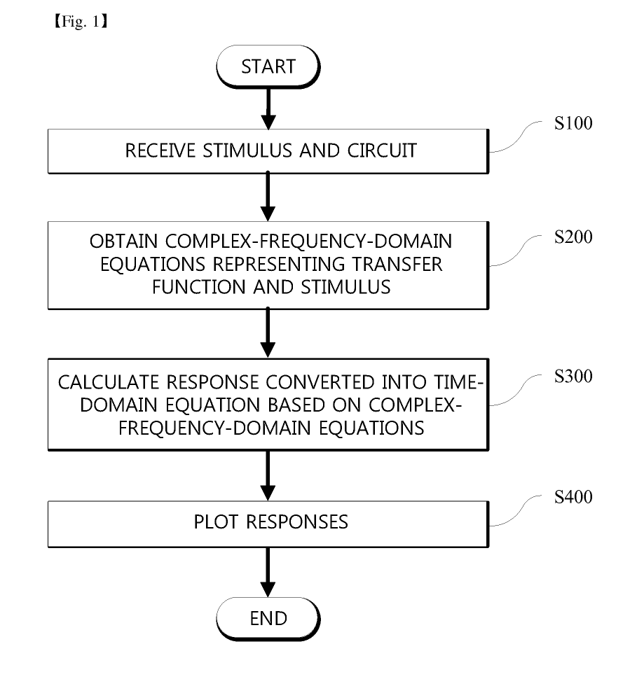

Hereinafter, exemplary embodiments will be described with reference to the accompanying drawings. FIG. 1 is a flowchart illustrating an operation according to an exemplary embodiment. Referring to FIG. 1, the exemplary embodiment includes receiving an input stimulus in a form of a linear combination of one or more basis functions and a set of coefficients describing the input stimulus signal as a function with respect to time and an electronic circuit or system (S100); converting the input stimulus in a form of a linear combination of one or more basis functions and a set of coefficients to an s-domain equation and obtaining an s-domain equation of the input-to-output transfer function of the electronic circuit or system (S200); and calculating the output response of the electronic circuit or system in a form of a linear combination of one or more basis functions and a set of coefficients describing the output response signal as a function with respect to time (S300).

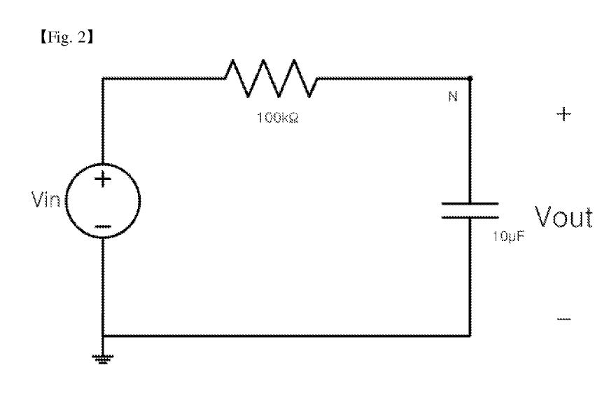

In S100, an electronic circuit or system of which output response to an input stimulus is to be simulated and an input stimulus in a form of a linear combination of one or more basis functions and a set of coefficients describing the input stimulus signal as a function with respect to time are input by a user. The electronic circuit or system input by the user may be an analog circuit, a digital circuit, and/or a mixed-signal circuit. When the electronic circuit or system input by the user is a digital circuit, there is a known method of calculating the output response using an event-driven method. However, when the circuit is an analog circuit or mixed-signal circuit, no known method for its purely event-driven simulation exists. For instance, the output response of an analog circuit may keep changing even when the input stimulus is at a constant voltage, and the existing simulator such as SPICE has to keep computing the time-value pairs composing the output response waveform. While some circuit simulators claim themselves as event-driven, it should be noted that they use the term “event-driven” in a different meaning than it is used in this disclosure. Those simulators refer to a method of partitioning the circuit or system into multiple parts and simulating only the parts that are active as an event-driven method, while this disclosure refers to a method of computing the output response only when the input stimulus changes even for the individual parts of the circuit or system as an event-driven method. The following description will use a first-order analog resistor-capacitor (RC) filter circuit shown in FIG. 2 as an example electronic circuit input by the user.

The form of an input stimulus used in an electronic circuit simulation may be a step function, a ramp function, an exponential function, an exponential function multiplied by a polynomial function, and any combination thereof, to name a few possibilities. These possible input stimulus waveforms can be collectively expressed using Equation 1 below. In other words, Equation 1 can be a step function when m=1 and a=0, an exponential function when m=1, and a ramp function when a=0 and m=2, for instance. Equation 1 can express many forms of signal functions that are meaningful in engineering. A stimulus having such a form may be applied to the circuit in the form of current or voltage.

The present invention uses the function in Equation 1 as a basis function to express a continuous-time analog signal, which is basically a (m-1)-th power of the time variable t multiplied by an exponential function e^{-at}.

$${ct}^{( m - 1 )} {e}^{( - at )} u ( t ) , \\ u ( t ) = \begin{matrix}1 & for t ≧ 0 , \\ 0 & elsewhere\end{matrix} \qquad [ Equation 1 ]$$

The coefficients c, m, and a are complex-valued in general. And this invention expresses both the input stimulus and output response of an electronic circuit or system x(t) in forms of a linear combination of one or more basis functions as shown below:

$$x ( t ) = {\sum }_{i} {c}_{i} {t}^{{m}_{i} - 1} {e}^{- {a}_{i} t} u ( t )$$

Hence, the set of coefficients {cᵢ}'s, {aᵢ}'s, and {mᵢ}'s define a continuous-time signal waveform x(t) as a function of time t for t≧0. It should be emphasized again that a set of values used for the prior-arts merely indicate the signal values simulated at different time points and do not serve as coefficients in a functional expression. Note that the unit step function u(t) in Equation 1 is mainly to indicate that the above functional expression for x(t) is valid only for the time after the set of coefficients {cᵢ}'s, {aᵢ}'s, and {mᵢ}'s are updated. Throughout this disclosure, it is implicitly assumed that the coefficients are updated with new values at t=0, and hence the above functional expression is valid only for t≧0. However, during the course of simulation, the coefficients may change in subsequent times, e.g. at t=t₀, in which case the above functional expression must be interpreted with a proper time shift t₀:

$$x ( t ) = {\sum }_{i} {{c}_{i } ( t - {t}_{0} )}^{{m}_{i} - 1} {e}^{- {a}_{i} ( t - {t}_{0} )} u ( t - {t}_{0} )$$

which is valid for t≧t₀.

In S200, an s-domain equation representing the input stimulus in a form of a linear combination of one or more basis functions and a set of coefficients and an s-domain equation of the input-to-output transfer function of the electronic circuit or system are obtained.

As an example, to obtain the s-domain equation for the input stimulus, a Laplace transform is performed on the time-domain expression of the input stimulus. The Laplace transform is defined as Equation 2 below. The Laplace transform facilitates a simple computation of the output response of an electronic circuit or system given its input stimulus.

F(s)=∫₀^{∞}f(t)e^{-st}dt [Equation 2]

Table 1 lists the Laplace transform of a few common functions. When the user applies a ramp function or an exponential function as a stimulus, the two stimuli have very different forms in the time-domain expressions, but their Laplace-transforms are both in the partial-fraction expansion forms and different only in the coefficient values. In general, any time-domain signal expressed in a form of a linear combination of one or more basis functions in Equation 1 transforms to a partial fraction expansion form in s domain.

TABLE 1

| | |
|---|---|
| ct^{(m-1)}e^{(-at)}u(t) | $\frac{b}{{( s + a )}^{m}}$ |
| cu(t) | $\frac{b}{s}$ |
| ctu(t) | $\frac{b}{{s}^{2}}$ |
| ce^{(-at)}u(t) | $\frac{b}{s + a}$ |
| cte^{(-at)}u(t) | $\frac{b}{{( s + a )}^{2}}$ |

(where a, b, and c all are complex-valued constants)

In S200, the input-to-output transfer function of the electronic circuit or system is defined as below. Given a linear system of which input signal x(t) and output signal y(t) have Laplace transforms of X(s) and Y(s), respectively, its input-to-output transfer function H(s) is defined as the ratio between Y(s) and X(s) as in Equation 3. In other words, the transfer function H(s) denotes a ratio of the Laplace-transformed output signal Y(s) to the Laplace-transformed input signal X(s). Also, when assuming zero initial states of electronic circuit or system for simplicity, the output response Y(s) of a given linear system can be obtained simply by multiplying the Laplace-transformed input signal X(s) and the input-to-output transfer function H(s) in s domain.

$$H ( s ) ≡ \frac{Y ( s )}{X ( s )} \qquad [ Equation 3 ]$$

The s-domain input-to-output transfer function of an electronic circuit or system can be obtained as follows. In an exemplary embodiment, the user may form and input the circuit in a simulation tool by disposing icons representing elements and connecting the disposed icons on a graphical user interface, or by designating nodes of the circuit and specifying elements connected between the nodes in a textual form. From the said circuit input, the simulation tools may extract the structural netlists defining the elements constituting the circuit and the connections among the elements, and form a differential equation or an equivalent model representing the circuit. The transfer function H(s) can be obtained by transforming the differential equation or equivalent model into the Laplace s-domain or by solving the s-domain equivalent circuit model of the electronic circuit or system.

An example, referring to FIG. 2, illustrates how a differential equation representing an electronic circuit can be formed from an extracted netlist. When a voltage at a node N connected between a capacitor and a resistor is Vout, the following equation is satisfied at the node N according to Kirchhoff's current law (KCL).

$$C \frac{d Vout}{d t} + \frac{Vout - Vin}{R} = 0$$

Therefore, by Laplace transforming this differential equation governing the output voltage Vout, an s-domain input-to-output transfer function H(s) can be found as follows. Here, the initial voltage across the capacitor at t=0, v(0), is assumed to be zero.

$$sC \cdot Vout ( s ) - Cv ( 0 ) + ( Vout ( s ) - Vin ( s ) ) / R = 0$$

$$H ( s ) = \frac{Vout ( s )}{Vin ( s )} = \frac{1}{1 + sRC}$$

Another example, referring to FIG. 3, illustrates how the s-domain input-to-output transfer function can be alternatively derived by solving the s-domain equivalent circuit model. FIG. 3 lists the s-domain equivalent expressions for the time-domain current-voltage equations for a resistor R, an inductor L, and a capacitor C, which are the passive elements used in analog circuits. Referring to (a) of FIG. 3, a resistor has an s-domain impedance Z(s)=V(s)/I(s) equal to R, where R is the resistance. Referring to (b) of FIG. 3, an inductor with an inductance L has an s-domain impedance of sL, of which initial current value i(0) may be indicated either with a voltage source having an initial voltage of Li(0) or with a current source having an initial current of i(0)/s. Likewise, referring to (c) of FIG. 3, a capacitor with a capacitance C has an s-domain impedance of 1/sC, of which initial voltage value v(0) may be indicated as a voltage source of v(0)/s or a current source of Cv(0).

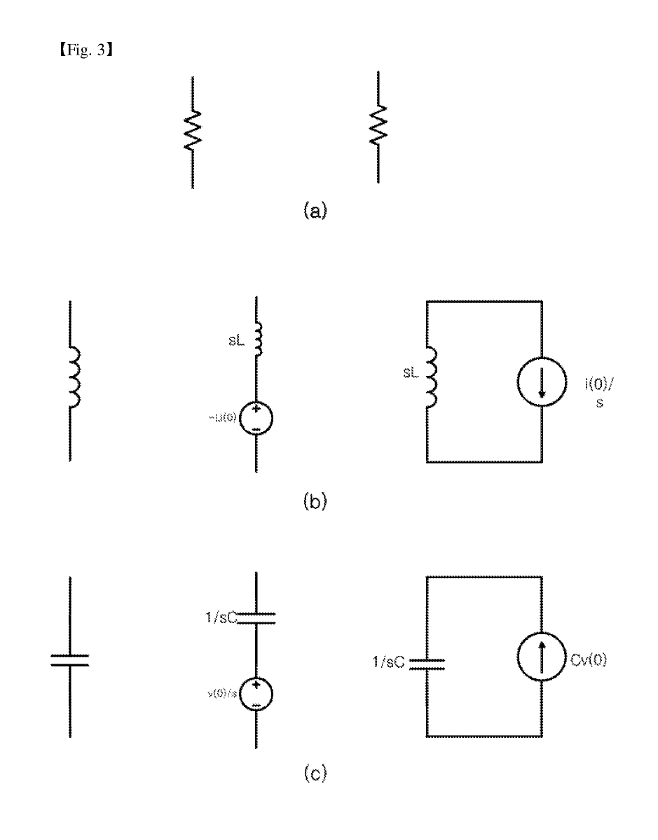

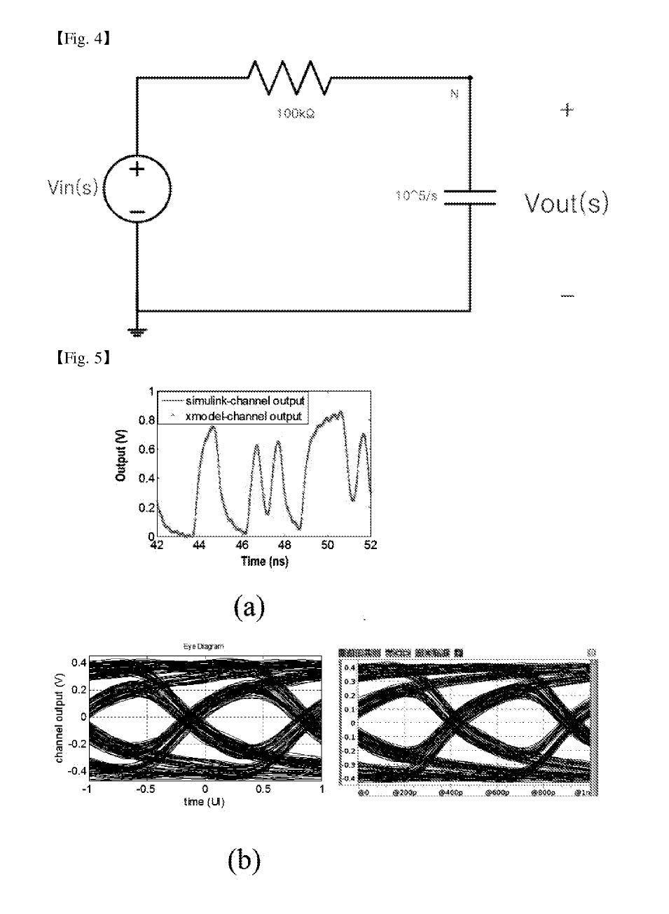

Based on the above-described results, an s-domain equivalent circuit of the exemplary circuit in FIG. 2 can be derived as shown in FIG. 4, and using the s-domain equivalent circuit, the input-to-output transfer function H(s) can be found as follows.

$$Vout ( s ) = \frac{1 / sC}{R + 1 / sC} Vin ( s )$$

$$H ( s ) = \frac{Vout ( s )}{Vin ( s )} = \frac{1}{1 + sRC}$$

Therefore, it is possible to obtain the same transfer function using any of the above methods.

Referring back to S300 of FIG. 1, The output response of the electronic circuit or system in a form of a linear combination of one or more basis functions and a set of coefficients is calculated based on the s-domain equation representing the electronic circuit or system and the s-domain equation representing the input stimulus. In an exemplary embodiment, the s-domain input-to-output transfer function H(s) and the s-domain expression for the input stimuli X(s) are algebraically multiplied in s-domain. Note that to compute an output response of a linear time-invariant (LTI) system in time domain, it is necessary to calculate the convolution integral between an input stimulus signal x(t) and an impulse response h(t) of the LTI system. On the other hand, in the Laplace s-domain, the output response can be obtained simply by multiplying H(s) and X(s), as described above.

When the input stimulus is represented as a linear combination of one or more basis functions as expressed in Equation 1, its s-domain equation X(s) always takes a partial fraction expansion form:

$$X ( s ) = {\sum }_{i} \frac{{b}_{i}}{{( s + {a}_{i} )}^{{m}_{i}}} .$$

where aᵢ, bᵢ, and mᵢ are complex-valued coefficients. Also, an electronic circuit or system with a finite number of poles and zeros has an s-domain transfer function in the same partial fraction expansion form:

$$H ( s ) = {\sum }_{j} \frac{{q}_{j}}{{( s + {p}_{j} )}^{{n}_{j}}}$$

where pⱼ, qⱼ, and nⱼ are complex-valued coefficients. Note that intentionally different coefficient symbols and indices are used for X(s) and H(s) for clarity even though both of them are in the same partial fraction expansion forms.

The output response Y(s), which is the product between the s-domain input stimulus X(s) and s-domain transfer function H(s), can be also obtained in a partial fraction expansion form as listed in Equation 4. Y(s) is a sum of the products between all possible combinations between one of the partial fraction terms in X(s) and one of the partial fraction terms in H(s) and each individual product terms can be decomposed into one or more partial fraction terms via partial fraction decomposition procedure.

$$[ Equation 4 ]$$

$${\sum }_{i} \frac{{b}_{i}}{{( s + {a}_{i} )}^{{m}_{i}}} \times {\sum }_{j} \frac{{q}_{j}}{{( s + {p}_{j} )}^{{n}_{j}}} = {\sum }_{i , j} \frac{{b}_{i}}{{( s + {a}_{i} )}^{{m}_{i}}} \times \frac{{q}_{j}}{{( s + {p}_{j} )}^{{n}_{j}}} = {\sum }_{i , j} ( {\sum }_{k = 1}^{{m}_{i}} \frac{{c}_{k}}{{( s + {a}_{i} )}^{k}} + {\sum }_{l = 1}^{{n}_{j}} \frac{{d}_{l}}{{( s + {p}_{j} )}^{l}} )$$

$$where , \\ {c}_{k} = \{ \begin{matrix}\frac{{b}_{i} \cdot {q}_{j}}{{( {p}_{j} - {a}_{i} )}^{{n}_{j}}} , & for k = {m}_{i} \\ \frac{{b}_{i} \cdot {q}_{j}}{{( {p}_{j} - {a}_{i} )}^{{m}_{i} + {n}_{j} - k}} \cdot \frac{{( - 1 )}^{{m}_{i} - k}}{( {m}_{i} - k ) !} \cdot {\prod }_{z = i}^{{m}_{i} - 1} ( {m}_{i} + {n}_{j} - 1 - z ) , & for k = {m}_{i} - 1 , … , 1\end{matrix} \\ {d}_{l} = \{ \begin{matrix}\frac{{b}_{i} \cdot {q}_{j}}{{( {a}_{i} - {p}_{j} )}^{{m}_{i}}} , & for l = {n}_{j} \\ \frac{{b}_{i} \cdot {q}_{j}}{{( {a}_{i} - {p}_{j} )}^{{n}_{j} + {m}_{i} - l}} \cdot \frac{{( - 1 )}^{{n}_{j} - l}}{( {n}_{j} - l ) !} \cdot {\prod }_{z = i}^{{n}_{j} - 1} ( {n}_{j} + {m}_{i} - 1 - z ) , & for l = {n}_{j} - 1 , … , 1\end{matrix}$$

where bᵢ, qⱼ, cₖ, and d₁ are complex-valued numbers.

As an example, it is assumed that a unit step function is applied as an input Vin to the RC filter shown in FIG. 2. As described above, an output Vout(s) may be calculated by multiplying the transfer function H(s) by the input stimulus, and a calculation result may be separated into partial fractions. When an inverse Laplace transform is performed on the calculation result separated into the partial fractions, it is possible to find a target response in the time domain.

$$Vout ( s ) = H ( s ) \times Vin ( s ) = \frac{1}{1 + sRC} \times \frac{1}{s} = \frac{1}{s} - \frac{RC}{1 + sRC}$$

$${v}_{out} ( t ) = {L}^{- 1} \{ Vout ( s ) \} = ( 1 - {e}^{- t / RC} ) \cdot u ( t )$$

In the simulation method according to this embodiment, unlike in a numerical analysis method according to related art, basis function coefficients of the response are calculated upon occurrence of every event, such as a change in a coefficient of the basis function. In other words, the simulation method according to this embodiment employs the event-driven method of calculating and updating basis function coefficients of the response as an event occurs, thus enabling a rapid and accurate simulation when compared to the related art.

In an exemplary embodiment, the output response may be plotted graphically by evaluating the obtained functional expression for the output response at one or more time points. In other words, using the set of coefficients {cᵢ}'s, {aᵢ}'s, and {mᵢ}'s constituting the functional expression in a form of a linear combination of one or more basis functions, a waveform plotting tool can compute the output response waveform at an arbitrary time point as necessary to display the waveform with a desired quality. This is in contrast to prior arts where a waveform plotting tool cannot compute the output response waveform at time points other than those provided by the simulation results, without resorting to some approximating methods such as interpolation or estimation.

The method of simulating an electronic circuit or system using the event-driven method according to this embodiment may be implemented as a computer program to be executed on a computer. In particular, the method may be executed in the context of Verilog, SystemVerilog, very high speed integrated circuit (VHSIC) hardware description language (VHDL) simulators which are the programs for simulating digital circuits and systems using an event-driven method.

### COMPARATIVE EXAMPLE

FIG. 5A is a diagram for a comparison between the circuit simulation results simulated by this embodiment and circuit simulation results simulated by MATLAB/Simulink, which is a commercial system simulation program. FIG. 5B is a diagram for a comparison between the circuit simulation results simulated by this embodiment and the circuit simulation results simulated by Simulation Program with Integrated Circuit Emphasis (SPICE), which is a commercial circuit simulation program. The circuit being simulated is a lossy transmission line channel of which s-domain input-to-output transfer function is extracted from a measured S-parameter model, using the “rationalfit” function available in MATLAB. The extracted input-to-output transfer function H(s) has 48 poles, implying that H(s) can be expressed using 48 partial fraction terms.

As shown in FIG. 5A, the results of this embodiment agree well with the results of MATLAB/Simulink. For a simulation time of 100 nsec, MATLAB/Simulink took 5.04 seconds, while this embodiment took only 0.82 seconds.

As shown in FIG. 5B, the results of this embodiment on the left-hand side match well with the results of SPICE on the right-hand side. For a simulation time of 100 nsec, SPICE took 334 seconds, while this embodiment took only 0.82 seconds. While the invention has been shown and described with reference to certain exemplary embodiments thereof, it shall be understood by those of ordinary skill in the art that various changes in form and details may be made therein without departing from the spirit and scope of the invention as defined by the appended claims.

1. A method of simulating an output response of an electronic circuit or system to an input stimulus, the method comprising:
receiving an input stimulus in a form of a linear combination of one or more basis functions and a set of coefficients describing the input stimulus signal as a function with respect to time;
converting the input stimulus in a form of a linear combination of one or more basis functions and a set of coefficients to an s-domain equation;
obtaining an s-domain equation of the input-to-output transfer function of the electronic circuit or system; and
calculating the output response of the electronic circuit or system in a form of a linear combination of one or more basis functions and a set of coefficients describing the output response signal as a function with respect to time.

2. The method of claim 1, wherein each of the one or more basis functions are in a form of c·t^{m-1}c^{-at}μ(t) where the coefficients c, m, and a are complex-valued constants and u(t) is a unit step function.

3. The method of claim 1, wherein the input-to-output transfer function is in a partial fraction expansion form in s domain.

4. The method of claim 1, wherein the input-to-output transfer function is found by converting a differential equation representing the electronic circuit or system into an s domain, or by using an s-domain equivalent circuit model of the electronic circuit or system.

5. The method of claim 1, wherein the calculating the output response of the electronic circuit or system in a form of a linear combination of one or more basis functions and a set of coefficients describing the output response signal as a function with respect to time comprises:
mulitplying the s-domain equation of the input stimulus and the s-domain equation of the input-to-output transfer function of the electronic circuit or system;
performing a partial fraction expansion of the result of the multiplication; and
converting the result of the partial fraction expansion into a form of a linear combination of one or more basis functions and a set of coefficients.

6. The method of claim 1, further comprising plotting the output response waveform graphically by evaluating the expression in a form of a linear combination of one or more basis functions and a set of coefficients at one or more time points.

7. The method of any one of the claims 1˜6, wherein the method is executed by one or more simulation tools among Verilog, SystemVerilog, and very high speed integrated circuit (VHSIC) hardware description language (VHDL).

8. A recording medium storing a circuit simulation program, the program comprising:
receiving an input stimulus in a form of a linear combination of one or more basis functions and a set of coefficients describing the input stimulus signal as a function with respect to time;
converting the input stimulus in a form of a linear combination of one or more basis functions and a set of coefficients to an s-domain equation;
obtaining an s-domain equation of the input-to-output transfer function of the electronic circuit or system; and
calculating the output response of the electronic circuit or system in a form of a linear combination of one or more basis functions and a set of coefficients describing the output response signal as a function with respect to time.

9. The recording medium of claim 8, wherein each of the one or more basis functions are in a form of c·t^{m-1}e^{-at}μ(t) where the coefficients c, m, and a are complex-valued constants and u(t) is a unit step function.

10. The recording medium of claim 8, wherein the input-to-output transfer function is in a partial fraction expanded form in s domain.

11. The recording medium of claim 8, wherein the input-to-output transfer function is found by converting a differential equation representing the electronic circuit or system into an s domain, or by using a Laplace equivalent circuit model of the electronic circuit or system.

12. The recording medium of claim 8, wherein the calculating the output response of the electronic circuit or system in a form of a linear combination of one or more basis functions and a set of coefficients describing the output response signal as a function with respect to time comprises:
mulitplying the s-domain equation of the input stimulus and the s-domain equation of the input-to-output transfer function of the electronic circuit or system;
performing a partial fraction expansion of the result of the multiplication; and
converting the result of the partial fraction expansion into a form of a linear combination of one or more basis functions and a set of coefficients.

13. The recording medium of claim 8, further comprising plotting the output response waveform graphically by evaluating the expression in a form of a linear combination of one or more basis functions and a set of coefficients at one or more time points.
